(19) United States
(12) Patent Application Publication
(10) Pub. No.: US 2012/0027146 A1
(43) Pub. Date: Feb. 2, 2012

(54) CLOCK RECOVERY IN A COMMUNICATIONS NETWORK

(75) Inventors: Robert Hodge, Warwickshire (GB); Stefano Ruffini, Roma (IT)

(73) Assignee: TELEFONAKTIEBOLAGET LM ERICSSON (PUBL), Stockholm (SE)

(21) Appl. No.: 13/202,247

(22) PCT Filed: Feb. 24, 2009
(86) PCT No.: PCT/EP2009/052165

§ 371 Date: Oct. 19, 2011

(51) Int. Cl. H04L 7/00

(52) U.S. Cl. 375/356

(57) ABSTRACT

The invention relates in general to clock recovery in a communications network, and in particular to clock recovery in a packet based communications network. Methods and apparatus are disclosed for determining a client timing signal 64, 70 for at least one client device 18, 20, 22, 54, 56, 92, 94, 96 at a master device 24, 58, 98. The client timing signal is compared 126 with a reference timing signal 76 of the master device. A timing difference value 36 is then determined 128 between the client timing signal and the reference timing signal. At least one packet indicative of the timing difference value is transmitted 130 from the master device 24, 58, 98 for receipt by the at least one client device for adjusting the client timing signal at the at least one client device.

### TECHNICAL FIELD

The invention relates in general to clock recovery in a communications network, and in particular to clock recovery in a packet based communications network.

### BACKGROUND

Communication networks are required to have timing functions to operate so that items of operational equipment in the network work to the same timing signal. There are many types of clock mechanisms that may be used to provide such timing functions which seek to provide accurate timing in the network to guarantee performance, and to minimise disruptions to communication services.

A Time Division Multiplexing (TDM) based network is a synchronous network which has a synchronous stream of data with a constant bit rate. Items of operational equipment in a TDM based network can obtain the timing signal from the synchronous data stream. The current trend in communications networks is for TDM based networks to migrate towards packet based technologies such as Ethernet based networks which require a different approach to timing because the stream of data is typically not synchronous.

It is known to provide a timing function in a packet based network by sending data packets to items of operational equipment from a master device. The master device has access to an accurate timing reference, such as via a Global Positioning Signal (GPS), and the inter-arrival time of the packets at the items of operational equipment represent the timing signal. Each item of operational equipment executes an algorithm to recover the timing signal based on an adaptive clock recovery algorithm which compares the arrival times of the packets with a local clock as per the standard ITU-T G.8261.

A problem associated with this approach is that the accuracy of the recovered clock at the operational equipment is affected by variable delays in the communications network. Such variable delays are generally more pronounced in the downlink direction from the master device, which is typically located centrally in the network, to the operational equipment, which may be located towards the edge of the network. Whereas the algorithm operates to filter out the packet delay variation this may be achieved with varying accuracy. Such packet delay variation has the consequence that the clock recovered at the items of operational equipment may be inaccurate which impairs the efficient operation of the network.

A further problem with such known packet based timing recovery methods is that each item of operational equipment is required to have complex functionality to run the algorithm which requires an expensive oscillator to act as the local clock.

### SUMMARY

What is required is an improved way of providing clock recovery in a packet based network, and to reduce the above-mentioned problems.

According to a first aspect of the invention, there is provided a method of performing clock recovery in a packet based communications network. The method comprising determining a client timing signal for at least one client device at a master device. The method comprising comparing the client timing signal with a reference timing signal of the master device. The method comprising determining a timing difference value between the client timing signal and the reference timing signal. The method comprising transmitting at least one packet from the master device for receipt by the at least one client device, wherein the at least one packet is indicative of the timing difference value for adjusting the client timing signal at the at least one client device.

Such a method has the advantage that comparing of the client timing signal with the reference timing signal is performed at the master device and not at the client device. This means that timing recovery at the client device can be performed in a simplified manner using a timing difference value. Since the client timing signal is determined at the master device any timing data relating to the client device is transmitted in the uplink. This has the advantage of being generally less susceptible to time delays than timing data that may be sent in the downlink used in the prior art. The timing difference value is sent in the downlink direction which it is not affected by delay variation that may be present in the network.

Preferably the method includes determining the client timing signal at the master device using at least one packet from said at least one client device.

Preferably the method further includes transmitting a request for timing information from the master device for receipt by the at least one client device for use in determining the client timing signal at the master device.

The method may include receiving a plurality of packets at the master device from the at least one client device for use in determining the client timing signal, wherein the packets are indicative of the client timing signal. The method may include selecting one or more packets from the plurality of packets for use in determining the client timing signal.

The method may include determining a plurality of different client timing signals from a plurality of client devices, wherein the plurality of different client timing signals are determined one after the other at the master device. This has the advantage that the different client timing signals are determined sequentially, which may utilise resources in an effective manner.

According to a second aspect of the invention there is provided a method of performing clock recovery in a packet based communications network. The method comprising transmitting a client timing signal from at least one client device for receipt by a master device. The method including receiving at least one packet from the master device at the at least one client device, wherein the at least one packet is indicative of a timing difference value between the client timing signal and a reference timing signal of the master device. The method including using the timing difference value for adjusting the client timing signal of the at least one client device.

Preferably the method further includes transmitting the client timing signal in response to receiving a request for timing information from the master device.

The method may include transmitting a plurality of packets for receipt by the master device for use in determining the client timing signal at the master device, wherein the packets are indicative of the client timing signal.

The method may include transmitting a plurality of different client timing signals from a plurality of client devices for receipt by the master device, and determining the plurality of different client timing signals one after the other at the master device.

The method may further comprise steps of the method according to the first aspect of the invention.

According to a third aspect of the invention there is provided a computer program embodied on a computer readable medium to perform clock recovery in a packet based communications network according to the first or second aspect of the invention.

According to a fourth aspect of the invention there is provided a master device for a packet based communications network. The master device comprising a timing recovery unit for determining a client timing signal of at least one client device. The master device operable to compare the client timing signal with a reference timing signal of the master device and determine a timing difference value between the client timing signal and the reference timing signal. The master device operable to transmit at least one packet indicative of the timing difference value for receipt by the at least one client device for adjusting the client timing signal at the at least one client device.

Preferably the at least one client device is arranged to determine the client timing signal using at least one packet from said at least one client device.

Preferably the timing recovery unit is arranged to transmit a request for timing information for receipt by the at least one client device for use in determining the client timing signal at the master device.

The timing recovery unit is arranged to receive a plurality of packets indicative of the client timing signal from the at least one client device to determine the client timing signal, wherein the packets are indicative of the client timing signal. The timing recovery unit is arranged to select one or more packets from the plurality of packets for use in determining the client timing signal.

The master device may further include a first plurality of timing recovery units operable to determine a second plurality of client timing signals from a second plurality of client devices, wherein there are less timing recovery units than client devices.

According to a fifth aspect of the invention there is provided a client device for a packet based communications network. The client device comprising a timing signal generator and a differential timing recovery unit. The client device operable to transmit a client timing signal of the client device for receipt by a master device. The differential timing recovery unit operable to receive at least one packet from the master device which is indicative of a timing difference value between the client timing signal and a reference timing signal of the master device. The client device operable to adjust the client timing signal with the timing difference value.

Preferably the client device is arranged to transmit the client timing signal in response to receiving a request for timing information from the master device.

The client device may be arranged to transmit a plurality of packets for receipt by the master device for use in determining the client timing signal at the master device, wherein the packets are indicative of the client timing signal.

According to a sixth aspect of the invention there is provided a communications network including a master device according to the third aspect or the fourth aspect of the invention, or including a client device according to the third aspect or the fifth aspect of the invention.

### BRIEF DESCRIPTION OF THE DRAWINGS

Other features of the invention will be apparent from the following description of preferred embodiments shown by way of example only with reference to the accompanying drawings, in which;

FIG. 1 shows a communications network for describing embodiments of the invention;

FIG. 2 shows the communications network of FIG. 1 in greater detail;

FIG. 3 shows a timing recovery unit of FIG. 2 according to an alternative embodiment;

FIG. 4 shows a differential clock recovery unit of FIG. 2 in greater detail;

FIG. 5 shows a network having a Digital Subscriber Line Access Multiplexer (DSLAM) according to an embodiment of the invention;

FIG. 6 shows a flow diagram illustrating a method of performing clock recovery at a master device according to an embodiment of the invention; and

FIG. 7 shows a flow diagram illustrating a method of performing clock recovery at a client device according to an embodiment of the invention.

### DETAILED DESCRIPTION

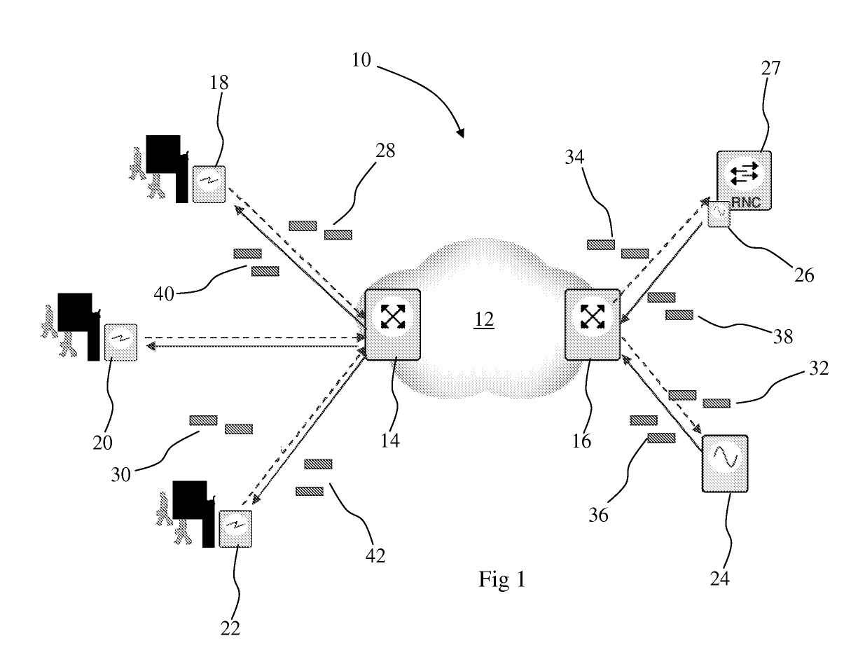

FIG. 1 shows a communications network for describing embodiments of the invention generally designated 10. The network 10 comprises a packet network 12 having two nodes 14, 16 at the edge thereof such as Ethernet switches or Internet Protocol (IP) nodes. The first node 14 is in communication with three client devices 18, 20, 22 which may be mobile base stations. The second node 16 is in communication with a master device 24 or 26 for providing a timing control function in the network 10. In FIG. 1 packets travelling in the uplink are shown with dotted arrows, whereas packets travelling in the downlink are shown with solid lines.

The master device 24 is a stand alone device, and may use a Network Time Protocol (NTP), or a Precision Timing Protocol (PTP) or any other similar protocol. The master device 26 is an integrated server which is part of a Radio Network Controller (RNC) 27 for a Wideband Code Division Multiple Access (WCDMA) radio network. Such a RNC allocates resources in the radio network and may operate as an aggregation point for a few hundred mobile base stations. It will be appreciated that the timing control function may be performed by either of the master devices 24, 26 according to different embodiments and depending on the application required.

In the network 10 the client devices 18, 20, 22 are arranged to send timing packets 28, 30 such as NTP or PTP timing packets in the uplink direction to the master device 24 or 26 via the nodes 14, 16. The timing packets represent a timing signal or local clock for the client devices 18, 20, 22. The timing packets are shown at 32 or 34 being received by the master device 24 or 26. The master device 24 or 26 then recovers the timing signals of the client devices 18, 20, 22 using the timing packets 32 or 34 and compares them to a reference timing signal of the master device 24 or 26. The master device 24 or 26 then sends timing correction packets 36 or 38 which are received by the client devices 18, 20, 22 as shown at 40, 42. The timing correction packets 40, 42 represent a difference value between the timing signal of the client devices 18, 22 and the reference timing signal of the master devices 24 or 26. The client devices 18, 22 then use the correction packets 40, 42 to adjust the timing signal or local clock of the client devices 18, 20, 22.

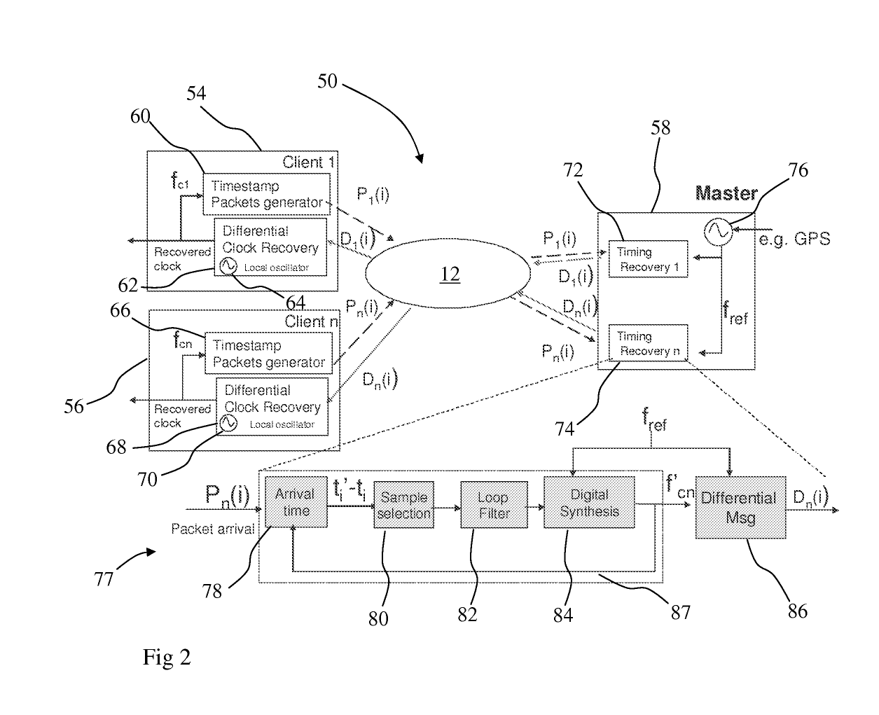

FIG. 2 shows the communications network of FIG. 1 in greater detail, generally designated 50. Like features to the arrangement of FIG. 1 are shown with like reference numerals. In FIG. 2 a first client device 54 and an n^{th} client device 56 are shown which are provided with timing information by the master device 58. The first client device 54 has a timestamp packet generator 60 operable to send timing packets P₁(i) in the uplink direction to the master device 58. The first client device 54 also has a differential clock recovery unit 62 which has a local oscillator 64 which generates the local timing reference for the first client device 54. The differential clock recovery unit 62 is operable to receive timing difference packets D₁(i) from the master device 58, and use the information they contain to control the local oscillator 64 to determine a recovered reference clock f_{ref}′ at the first client device 54. The n^{th} client device 56 also has a timestamp packet generator 66 operable to send timing packets Pₙ(i) in the uplink direction to the master device 58. The n^{th} client device 56 also has a differential clock recovery unit 68 which has a local oscillator 70 which generates the local timing reference for the n^{th} client device 56. The differential clock recovery unit 68 is operable to receive timing difference packets Dₙ(i) from the master device 58, and use the information they contain to control the local oscillator 70 to determine a recovered reference clock f_{ref}′ at the n^{th} client device 56.

The master device 58 has a timing recovery unit 72 for the first client device 54, and a timing recovery unit 74 for the n^{th} client device 56. The timing recovery units 72, 74 implement a clock recovery function for each of the n client. The timing recovery unit 72 is operable to receive the timing packets P₁(i) from the first client device 54 and to send the timing difference packets D₁(i) to the first client device 54. The timing recovery unit 74 is operable to receive the timing packets Pₙ(i) from the n^{th} client device 56 and to send the timing difference packets Dₙ(i) to the n^{th} client device 56. The master device 58 is also provided with an accurate reference timing signal 76 which is locked to a Global Positioning System (GPS) signal, which is passed to the timing recovery units 72, 74. It will be appreciated that the timing packets Pₙ(i) and P₁(i) are generated by the client devices 54, 56 according to respective local oscillators 64, 70, whereas the timing difference packets D₁(i) and Dₙ(i) are generated by the master device 58 which relates to the reference timing signal 76. In practice at least one the timing packet Pₙ(i) and P₁(i) is required, and at least one timing difference packets D₁(i) and Dₙ(i) is required.

The operation of the timing recovery unit 74 is shown in a flow diagram at the bottom of FIG. 2, generally designated 77. A request for the n^{th} client device 56 to send timing packets Pₙ(i) is sent from the timing recovery unit 74. Upon arrival of the timing packets Pₙ(i) at the timing recovery unit 74 a time error is calculated by comparing the actual arrival time with the expected arrival time shown at 78 by tᵢ′−tᵢ. A sample of the packets Pₙ(i) is then selected as shown at 80 according to an appropriate principle such as the selection of packets having a minimum delay. Typically more than one packet is needed to provide information about an average packet due to packet jitter or noise that may be introduced by the network 52. Appropriate averaging of the packets Pₙ(i) is required to filter out the jitter or noise. The sample is then passed to a loop filter 82 which is, for example, a low pass filter, an Exponentially Weighted Moving Average (EWMA) filter, or a Kalman filter. The loop filter 82 operates to provide an improved sample to remove phase noise so that an accurate replication f′_{cn} of the local oscillator 70 of the n^{th} client device 56 can be determined by the digital synthesis device 84 using the accurate reference timing signal 76 shown at f_{ref}. The digital synthesis device 84 then passes the accurate replication f′_{cn} to the differential messaging unit 86 to compare the difference with the reference timing signal 76 shown at f_{ref}. The differential messaging unit 86 then encodes the difference and generates a differential message Dₙ(i) which can be sent to the n^{th} client device 56. The differential message Dₙ(i) is then used by the n^{th} client device 56 to adjust the local oscillator 70 to recover the reference timing signal 76 at the n^{th} client device 56. The timing recovery unit 74 may have an analogue Phase-Locked Loop (PLL) device at the output of the digital synthesis device 84 in order to reduce jitter that may be generated by the digital synthesis device 84. The timing recovery unit 74 then loops the signal f′_{cn} back as shown by the feedback arrow 87 to calculate a time error at 78. The feedback arrow 87 is required for convergence of the calculation.

In this way the master device 58 performs a clock recovery operation for each of the client devices 1-n. In an alternative arrangement each timing recovery device 72, 74 may implement clock recovery for a plurality of client devices 54, 56 by sampling packets from the plurality of client devices one at a time. In this arrangement respective client timing signals from the plurality of client devices are determined sequentially so that the clock of one client device 54 is recovered before moving on to determine the clock of another client device 56. The master device 58 may dedicate 2-3 hours for one client device 54 before moving on to the next client device 56. As soon as the differential message Dₙ(i) for one client is calculated, the timing recovery unit 74 is reset and dedicated to the next client device until all client devices have been provided with differential messages Dₙ(i). In this way it is not necessary to implement hundreds of timing recovery units 72, 74 for hundreds of client devices. In one embodiment the ratio of timing recovery units 72, 74 to client devices 54, 56 is 1:10.

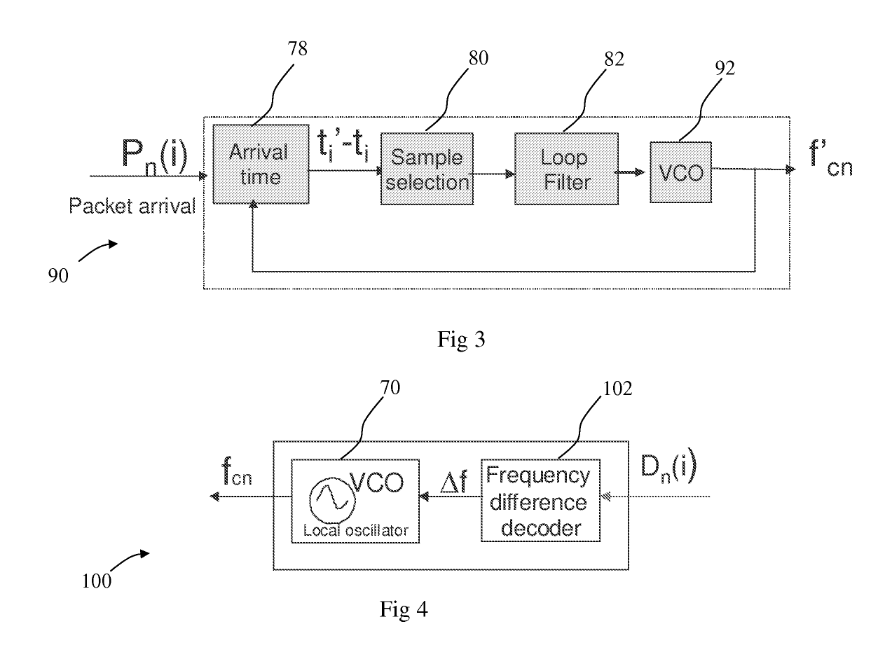

FIG. 3 shows a timing recovery unit of FIG. 2 according to an alternative embodiment, generally designated 90. Like features to the arrangement of FIG. 2 are shown with like reference numerals. In FIG. 3 a Voltage-Controlled Oscillator (VCO) 92 is included after the loop filter 82 to provide the reference timing signal 76 f_{ref}. The timing recovery unit 90 and the differential messaging unit 86 connected after the unit 90, may be used instead of the timing recovery units 72, 74 shown in FIG. 2. In FIG. 3 the local reference timing signal of the master device 58 is continuously controlled by means of the VCO 92.

FIG. 4 shows a differential clock recovery unit of FIG. 2 in greater detail, generally designated 100. Features common to the embodiment of FIG. 2 are shown with like reference numerals. In FIG. 4 the differential message Dₙ(i) is shown to be input to a frequency difference decoder 102 which is operable to determine a frequency correction Δf. The frequency correction Δf is then input to the local oscillator 70 to adjust the timing signal of the n^{th} client device 56 to provide a corrected client timing signal f_{cn} which is a replica of the reference timing signal 76 of the master device 58. It will be appreciated that the local oscillator 70 may be a VCO which may have the advantage of keeping costs to a minimum. In this way the remote clock frequency at the n^{th} client device 56 is adjusted to the reference timing signal 76 of the master device 58 by summing the local oscillator 70 with the frequency correction Δf which was encoded in the differential message Dₙ(i).

In this way it can be seen that the arrival times of the timing packets Pₙ(i) and P₁(i) are used by the timing recovery units 72, 74, 90 to determine timing of the local oscillators 64, 70. In contrast the timing difference packets D₁(i) and Dₙ(i) contain difference information that can be used by the differential clock recovery units 62, 68, 100.

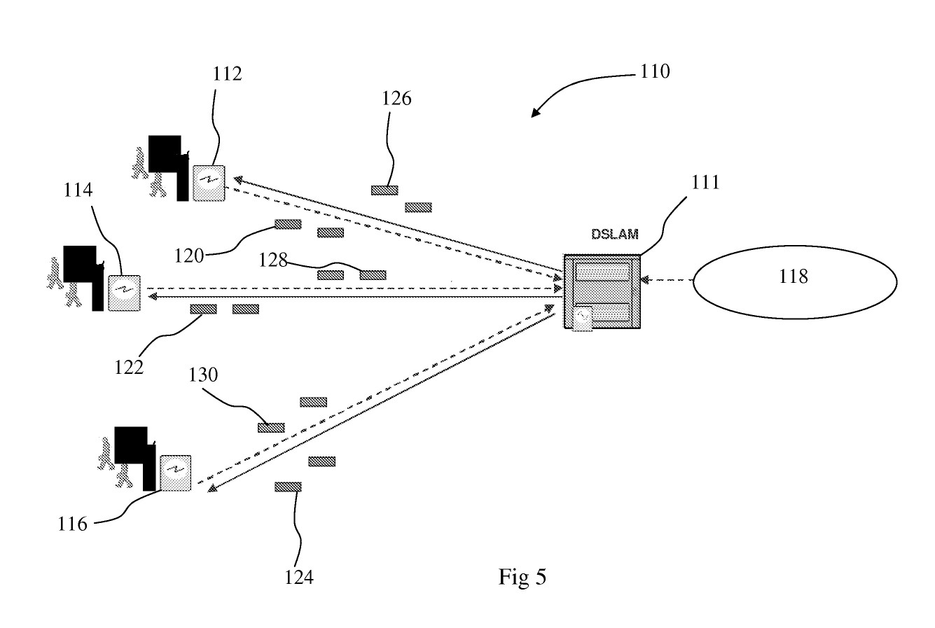

FIG. 5 shows a network having a Digital Subscriber Line Access Multiplexer (DSLAM) according to an embodiment of the invention, generally designated 110. The network 110 includes a DSLAM 111 which is in communication with three client devices 112, 114, 116. The DSLAM 111 is integrated as a master device which could use the Network Time Protocol (NTP), or the Precision Timing Protocol (PTP) or any other suitable protocol. Each of the client devices 112, 114, 116 are arranged to send NTP or PTP timing packets 120, 122, 124 to the DSLAM 111. The DSLAM 110 is also in communication with a synchronous Ethernet core network 118 for receiving a reference timing signal f_{ref}. Alternatively the DSLAM 110 may obtain the reference timing signal f_{ref} in any other way such as connection to a Synchronous Digital Hierarchy (SDH) or connection to a GPS signal. The DSLAM 111 compares the timing packets 120, 122, 124 with the reference timing signal f_{ref} to determine timing correction packets 126, 128, 130 for sending to each of the three client devices 112, 114, 116. In the arrangements of FIG. 5 there are a limited number of client devices 112, 114, 116 which may be an advantageous application for the embodiment of the invention which includes a DSLAM 111. It will be appreciated that an advantage of the arrangement of FIG. 5 is that the reference timing signal is provided via the DSLAM 111 being in communication with the synchronous Ethernet core network 118.

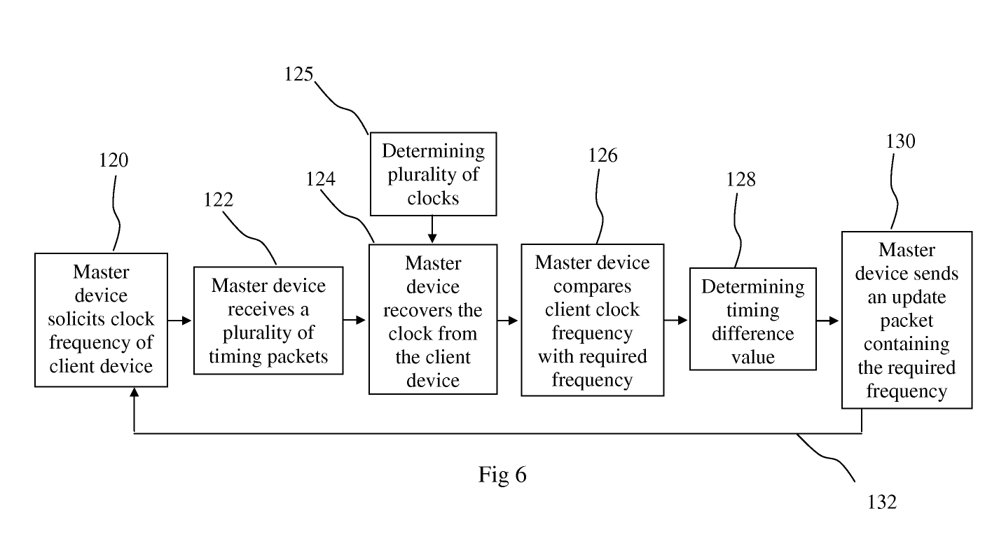

FIG. 6 shows a flow diagram illustrating a method of performing clock recovery at a master device according to an embodiment of the invention. The method includes determining a client timing signal for at least one client device at a master device as shown at step 124. This means that the master device recovers the clock from the client device. The method then compares the client timing signal with a reference timing signal of the master device which is the required frequency as shown at step 126. The method then determines a timing difference value between the client timing signal and the reference timing signal as shown at step 128. The method then transmits at least one packet indicative of the timing difference value from the master device for receipt by the at least one client device for adjusting the client timing signal at the at least one client device as shown at step 130. The at least one packet is indicative of the timing difference in that it contains timing difference information to allow the at least one client device to adjust its client timing signal. The method may include determining the client timing signal at the master device using the packet.

The method further includes the master device soliciting the clock frequency of the client device, as shown at step 120. This may be performed by transmitting a request for timing information from the master device for receipt by the at least one client device for use in determining the client timing signal at the master device.

The method may include the master device receiving a plurality of packets from the at least one client device for use in determining the client timing signal, wherein the packets are indicative of the client timing signal, as shown at step 122. It will be appreciated that the method further includes selecting one or more packets from the plurality of packets for use in determining the client timing signal. An average timing difference value may be determined from the plurality of packets indicative of the client timing signals.

The method may further include determining a plurality of different client timing signals at respective timing recovery units of the master device. The method may include determining a plurality of different client timing signals from a plurality of client devices at the master device, as shown at step 125, wherein the plurality of different client timing signals are determined one after the other at the master device. This has the advantage that the different client timing signals are determined sequentially, which may provide a more efficient management of the network implementing the method. The method then repeats as shown at step 132.

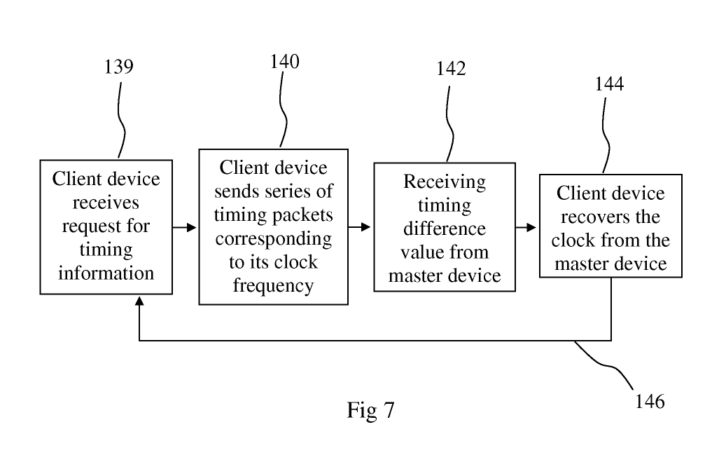

FIG. 7 shows a flow diagram illustrating a method of performing clock recovery at a client device according to an embodiment of the invention. The method comprising transmitting a client timing signal from at least one client device for receipt by a master device, as shown at step 140. The method includes receiving at least one packet from the master device at the at least one client device, wherein the at least one packet is indicative of a timing difference value between the client timing signal and a reference timing signal of the master device as shown at step 142. The method includes using the timing difference value for adjusting the client timing signal of the at least one client device, as shown at step 144.

The method further includes transmitting the client timing signal in response to receiving a request for timing information from the master device, as shown at step 139. This may be performed by transmitting a plurality of packets for receipt by the master device for use in determining the client timing signal at the master device, wherein the packets are indicative of the client timing signal, as shown at step 140.

The method may further including transmitting a plurality of different client timing signals from a plurality of client devices for receipt by the master device, and determining the plurality of different client timing signals one after the other at the master device. The method may further comprise steps of the method shown with reference to FIG. 6. The method then repeats as shown at step 146.

The arrangements of FIGS. 1-7 show how synchronization information is transferred to a client device using a clock recovery algorithm hosted in the master device. Hosting of the clock recovery algorithm in the master device has the advantage that any critical packets that may be sensitive to delay are only sent in the uplink direction. It will be appreciated that in the uplink direction the delay variation is generally lower and the performances are expected to be better. In comparison the downlink direction is generally noisier. Timing information is distributed to the clients in the downlink according to a differential approach that, by definition, is not affected by the packet delay variation.

The above-described embodiments are particularly, but not exclusively, relevant to frequency synchronization aspects of mobile technologies such as the Global System for Mobile Communications (GSM), Wideband Code Division Multiple Access (WCDMA) and in the future Long Term Evolution (LIE) successor to WCDMA. These applications generally require accurate frequency and/or time synchronization references in order to operate effectively.

1.-22. (canceled)

23. A method of performing clock recovery in a packet based communications network comprising:
determining a client timing signal for at least one client device at a master device;
comparing the client timing signal with a reference timing signal of the master device;
determining a timing difference value between the client timing signal and the reference timing signal; and
transmitting at least one packet from the master device for receipt by the at least one client device, wherein the at least one packet is indicative of the timing difference value for adjusting the client timing signal at the at least one client device.

24. A method according to claim 23 and further including determining the client timing signal at the master device using at least one packet from said at least one client device.

25. A method according to claim 23 and further including transmitting a request for timing information from the master device for receipt by the at least one client device for use in determining the client timing signal at the master device.

26. A method according to claim 23, and further including receiving a plurality of packets at the master device from the at least one client device for use in determining the client timing signal, wherein the packets are indicative of the client timing signal.

27. A method according to claim 26 and further including selecting one or more packets from the plurality of packets for use in determining the client timing signal.

28. A method according to claim 23 and further including determining a plurality of different client timing signals from a plurality of client devices, wherein the plurality of different client timing signals are determined one after the other at the master device.

29. A method of performing clock recovery in a packet based communications network comprising:
transmitting a client timing signal from at least one client device for receipt by a master device;
receiving at least one packet from the master device at the at least one client device, wherein the at least one packet is indicative of a timing difference value between the client timing signal and a reference timing signal of the master device; and
using the timing difference value for adjusting the client timing signal of the at least one client device.

30. A method according to claim 29 and further including transmitting the client timing signal in response to receiving a request for timing information from the master device.

31. A method according to claim 29 and further including transmitting a plurality of packets for receipt by the master device for use in determining the client timing signal at the master device, wherein the packets are indicative of the client timing signal.

32. A method according to claim 29 and further including transmitting a plurality of different client timing signals from a plurality of client devices for receipt by the master device, and determining the plurality of different client timing signals one after the other at the master device.

33. A method according to claim 29 further comprising the steps of:
determining a client timing signal for at least one client device at a master device;
comparing the client timing signal with a reference timing signal of the master device;
determining a timing difference value between the client timing signal and the reference timing signal; and
transmitting at least one packet from the master device for receipt by the at least one client device, wherein the at least one packet is indicative of the timing difference value for adjusting the client timing signal at the at least one client device.

34. A master device for a packet based communications network, the master device comprising a timing recovery unit for determining a client timing signal of at least one client device, the master device operable to compare the client timing signal with a reference timing signal of the master device and determine a timing difference value between the client timing signal and the reference timing signal, the master device operable to transmit at least one packet indicative of the timing difference value for receipt by the at least one client device for adjusting the client timing signal at the at least one client device.

35. A master device according to claim 34 further arranged to determine the client timing signal using at least one packet from said at least one client device.

36. A master device according to claim 34 wherein the timing recovery unit is arranged to transmit a request for timing information for receipt by the at least one client device for use in determining the client timing signal at the master device.

37. A master device according to claim 34 wherein the timing recovery unit is arranged to receive a plurality of packets indicative of the client timing signal from the at least one client device to determine the client timing signal, wherein the packets are indicative of the client timing signal.

38. A master device according to claim 37 wherein the timing recovery unit is arranged to select one or more packets from the plurality of packets for use in determining the client timing signal.

39. A master device according to claim 34 and further including a first plurality of timing recovery units operable to determine a second plurality of client timing signals from a second plurality of client devices, wherein there are less timing recovery units than client devices.

40. A client device for a packet based communications network, the client device comprising a timing signal generator and a differential timing recovery unit, the client device operable to transmit a client timing signal of the client device for receipt by a master device, the differential timing recovery unit operable to receive at least one packet from the master device which is indicative of a timing difference value between the client timing signal and a reference timing signal of the master device, the client device operable to adjust the client timing signal with the timing difference value.

41. A client device according to claim 40 arranged to transmit the client timing signal in response to receiving a request for timing information from the master device.

42. A client device according to claim 40 arranged to transmit a plurality of packets for receipt by the master device for use in determining the client timing signal at the master device, wherein the packets are indicative of the client timing signal.
